(19) United States
(12) Patent Application Publication
(10) Pub. No.: US 2025/0180051 A1
(43) Pub. Date: Jun. 5, 2025

(54) MATERIAL FASTENING SYSTEM

(71) Applicant: Adorn New York, Inc., Brooklyn, NY (US)

(72) Inventors: Raqquyah Webb, Brooklyn, NY (US); Edwin Chan, Brooklyn, NY (US)

(21) Appl. No.: 18/962,067

(22) Filed: Nov. 27, 2024

Related U.S. Application Data
(60) Provisional application No. 63/604,651, filed on Nov. 30, 2023.

(51) Int. Cl. F16B 7/18; A44C 5/02

(52) U.S. Cl. CPC F16B 7/18; A44C 5/02

(57) ABSTRACT

A material fastening system includes a body structure and a rod structure. The body structure includes a handle portion, a first protruding portion extending from the handle portion and forming a rod channel, and a second protruding portion extending from the handle portion that forms a fastener opening configured to receive a fastener, wherein one or more materials are to be disposed between the first protruding portion and the second protruding portion. The rod structure is configured to at least partially pass through the rod channel and at least one of penetrate the one or more materials disposed between the first protruding portion and the second protruding portion or secure the fastener to the one or more materials disposed between the first protruding portion and the second protruding portion.

### RELATED APPLICATIONS

This application claims the benefit of Provisional Application No. 63/604,651, filed Nov. 30, 2023 which is incorporated by reference in its entirety.

### TECHNICAL FIELD

Aspects and embodiments of the disclosure relate to material fastening, and more specifically, to a material fastening system.

### BACKGROUND

One or more materials may be secured together via one or more processes. Materials secured together may be used as jewelry.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIGS. 1A-B illustrate a material fastening system, in accordance with some embodiments of the disclosure.

FIGS. 2A-F illustrate rod structures of material fastening systems, in accordance with some embodiments of the disclosure.

FIG. 3 illustrates a cross-sectional side view of components of a material fastening system, in accordance with some embodiments of the disclosure.

FIGS. 4A-C illustrate material fastening systems, in accordance with some embodiments of the disclosure.

FIG. 5 depicts a flow diagram of a method for using a material fastening system, in accordance with some embodiments of the disclosure.

FIG. 6 illustrates components of a material fastening system, in accordance with some embodiments of the disclosure.

FIGS. 7A-B illustrate components of material fastening systems, in accordance with some embodiments of the disclosure.

FIGS. 8A-B illustrate components of material fastening systems, in accordance with some embodiments of the disclosure.

FIGS. 9A-C illustrate components used with material fastening systems, in accordance with some embodiments of the disclosure.

### DETAILED DESCRIPTION OF EMBODIMENTS

Embodiments described herein are related to material fastening systems (e.g., configured to pierce, rivet, flare, stake, and/or the like one or more materials).

There is a common need for securing one or more materials together. This is especially true when creating items that require more than one material. For example, to create an earring, the decorative part of the earring (e.g., gemstone, figure, fabric, etc.) is to be secured to the post of an earring. Another example includes fastening (e.g., folding and securing) one or more pieces of fabric to create a specific shape (e.g., creating a pouch, pocket, broach, or bag out of one or more pieces of fabric by folding the one or more pieces of fabric and securing the fabric along a perimeter of the fabrics).

Conventionally there are limits in how to secure one or more pieces of material to each other and what types of materials can be secured without sophisticated or industrial tools. For instance, to secure one or more pieces of metal together, conventionally the pieces of metal are to be welded or soldered together. This requires access to welding equipment or soldering iron (e.g., soldering tool) and solder to perform this task. Both conventional welding and soldering are difficult tasks that require extensive training and practice before they can be performed proficiently. Conventionally, people do not have the time or resources to devote to train and practice in these areas. Faulty welding or soldering can lead to material waste, faulty products, harm to the user, and/or the like.

Conventional securing mechanisms have limited strength to secure one or more materials to each other. For instance, to secure the decorative part of an earring to the post of an earring, the two pieces may be soldered or glued together. As described above, welding and soldering are difficult processes, so glue may be used, which poorly secures the pieces together and the pieces are prone to falling apart after continued use.

Other conventional solutions to rivet one or more materials together are often difficult to use and are error prone. A conventional rivet tool may be difficult to hold in one hand and/or may require multiple separate components to secure a rivet to materials. For instance, to secure a rivet to materials, a tool is to be used to create a hole in the materials and then a separate component is to be used to secure the rivet to the materials. This could result in lost components while moving the materials from punching a hole to inserting the rivet. Furthermore, conventional solutions take time and practice to use correctly, resulting in wasted materials and time.

The devices, systems, and methods of the material fastening system disclosed in this application overcome at least the challenges mentioned above.

A material fastening system may include a body structure and a rod structure. The body structure may further include a handle portion, a first protruding portion, and a second protruding portion. The first protruding portion may extend from the handle portion and form a rod channel. The second protruding portion may extend from the handle portion and form a fastener opening associated with receiving a fastener. One or more materials may be disposed between the first protruding portion and the second protruding portion. The one or more materials may include one or more of metal, paper, plastic, cloth, leather, suede, materials with thickness up to 24 gauge, etc. The rod structure may be one of a plurality of rod structures, where a first rod structure may be configured to at least partially pass through the rod channel. In some embodiments, the first rod structure may be configured to penetrate the one or more materials disposed between the first protruding portion and the second protruding portion. In some embodiments, a second rod structure of the plurality of rod structures may be configured to secure (e.g., rivet, flare, stake, etc.) the fastener to the one or more materials disposed between the first protruding portion and the second protruding portion.

The present disclosure has advantages over conventional solutions. The present disclosure may allow for securing materials together without gluing, welding, and/or soldering of conventional solutions. This provides the advantage of less material waste, less faulty products, and less harm to the user compared to conventional solutions. The present disclosure may allow joining of different materials with different securing mechanisms that are not possible with conventional solutions. The present disclosure may join materials more securely together than some conventional solutions. The material fastening system of the present disclosure may be secured using only one hand. The present disclosure may allow a user to punch a hole in one or more materials and secure the one or more materials together using the same tool and without unnecessarily moving the one or more materials.

The present disclosure may be used to make products such as earrings, broaches, bracelets, keychains, leather goods, metal art, custom accessories, etc. The present disclosure may be used to add an interface to products to attach (e.g., hang) the products on a surface, such as a wall, a shelf, windowsill, a fireplace mantle, etc.

Although some embodiments of the present disclosure discuss a material fastening system to secure materials together to produce jewelry, in some embodiments, the material fastening system is used to secure material together to produce other products.

Although some embodiments of the present disclosure discuss a system to secure (e.g., rivet) materials together using a rivet, in some embodiments, the systems of the present disclosure may be used to pierce material and/or to secure (e.g., crimp, rivet, flare, stake, etc.) material together using one or more types of fasteners, such as a rivet, flare, an eyelet, a grommet, a boss, a tenon, and/or the like.

A material fastening system of the present disclosure may be configured to one or more of pierce, secure, fasten, rivet (e.g., form solid tenon into a rivet), flare (e.g., form a hollow tenon into a flare), stake (e.g. form a boss into a hole), etc. one or more materials. The material fastening system of the present disclosure may be one or more of a material riveting system, a material flaring system, a material staking system, a material securing system, a material piercing system, etc. The material fastening system may be a material fastening tool.

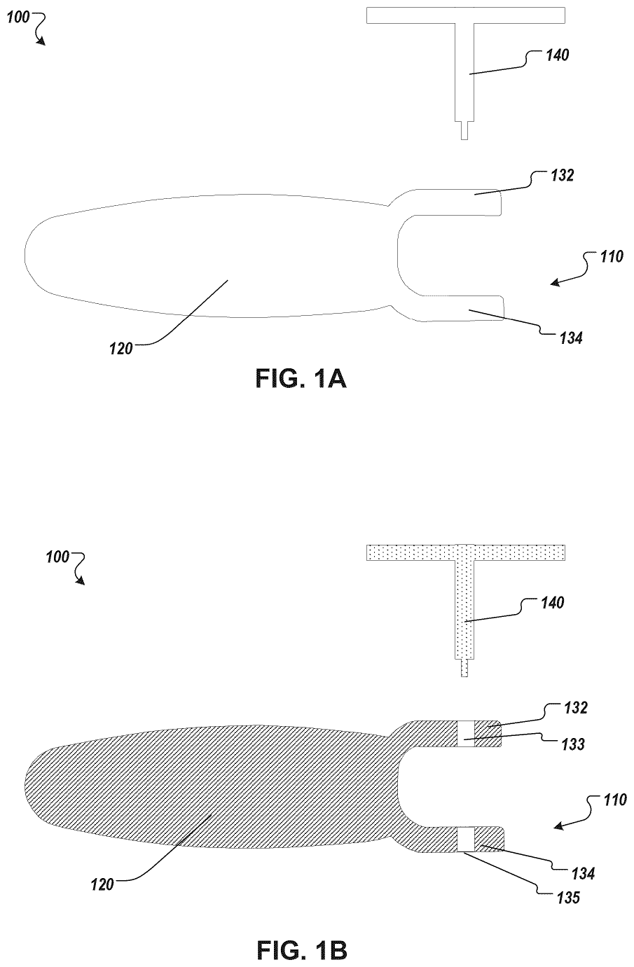

FIGS. 1A-B illustrate material fastening system 100 (e.g., material fastening device and rod structure), in accordance with some embodiments of the disclosure. FIG. 1A illustrates a front view of a material fastening system 100. FIG. 1B illustrates a front cross-sectional view of a material fastening system 100 (e.g., the same material fastening system 100 as FIG. 1A). The material fastening system 100 includes a body structure 110 and a rod structure 140 (e.g., T-bar rod structure that has a rod handle and a rod post that are substantially perpendicular to each other).

The body structure 110 may include a handle portion 120 (e.g., elongated ergonomic handle), a first protruding portion 132, and a second protruding portion 134. In some embodiments, the body structure 110 may be a material fastening device. The handle portion 120 may be configured to be held via a hand of a user to secure materials together. In some embodiments, the handle portion 120 may be a curved handle, such that is provides a comfortable or natural grip in a single hand of a user (e.g., reducing strain on the user's hand and/or wrist) during use. The first protruding portion 132 and the second protruding portion 134 may protrude from the handle portion 120. The first protruding portion 132 and the second protruding portion 134 may be offset from each other so that one or more materials may be placed between the first protruding portion 132 and the second protruding portion 134. The first protruding portion 132 may form a rod channel 133 that traverses from an upper surface of the first protruding portion 132 through the first protruding portion 132 to a lower surface of the first protruding portion 132. In some embodiments, the rod channel 133 may be configured such that at least a portion of the rod structure 140 may pass through the rod channel 133. In some embodiments, the rod channel 133 may be a threaded rod channel. The second protruding portion 134 may form a fastener (e.g., rivet) opening 135. The fastener opening 135 may traverse from an upper surface of the second protruding portion 134 through the second protruding portion 134 to a lower surface of the second protruding portion 134. In some embodiments, the fastener opening 135 may be configured such that at least a portion of a fastener (e.g., fastener post or rivet post) may pass through the fastener opening 135. In some embodiments, the fastener opening 135 may be a threaded fastener opening. In some embodiments, the fastener opening 135 may be configured to receive a material fastening receptacle structure (e.g., the material fastening receptacle structure 310 of FIG. 3).

In some embodiments, the body structure 110 may be made from plastic, metal, and/or one or more other sturdy (e.g., rigid) materials.

In some embodiments, the handle portion 120 may be made from the same material as the rest of the body structure 110 (e.g., first protruding portion 132 and/or second protruding portion 134). In some embodiments, the handle portion 120 may be made from a material different from the material of one or more other portions of the body structure 110 (e.g., first protruding portion 132 and/or second protruding portion 134). In some embodiments, the handle portion 120 may be made of or include a nonslip or grip material, such as rubber or silicone.

In some embodiments, the handle portion 120 may be operatively coupled to (e.g., attached to) the first protruding portion 132 and the second protruding portion 134. In some embodiments, the first protruding portion 132 and the second protruding portion 134 may protrude from the handle portion 120. In some embodiments, the first protruding portion 132 and the second protruding portion 134 may be made from the same material as one or other portions of the body structure 110 (e.g., handle portion 120). In some embodiments, the first protruding portion 132 and the second protruding portion 134 may be made from a material different from the material of one or more other portions of the body structure 110 (e.g., handle portion 120). In some embodiments, the handle portion 120, the first protruding portion 132, and the second protruding portion 134 are integral to each other (e.g., are a single structure).

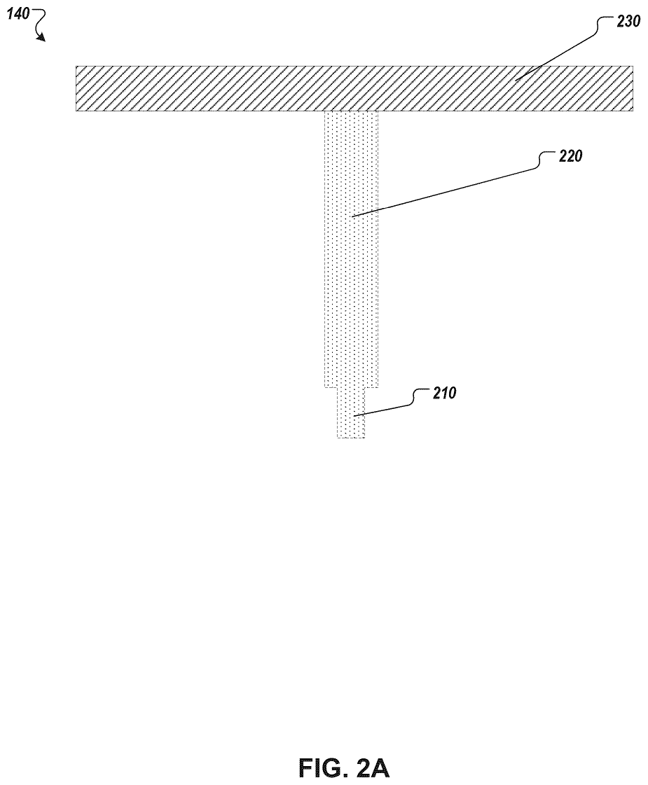

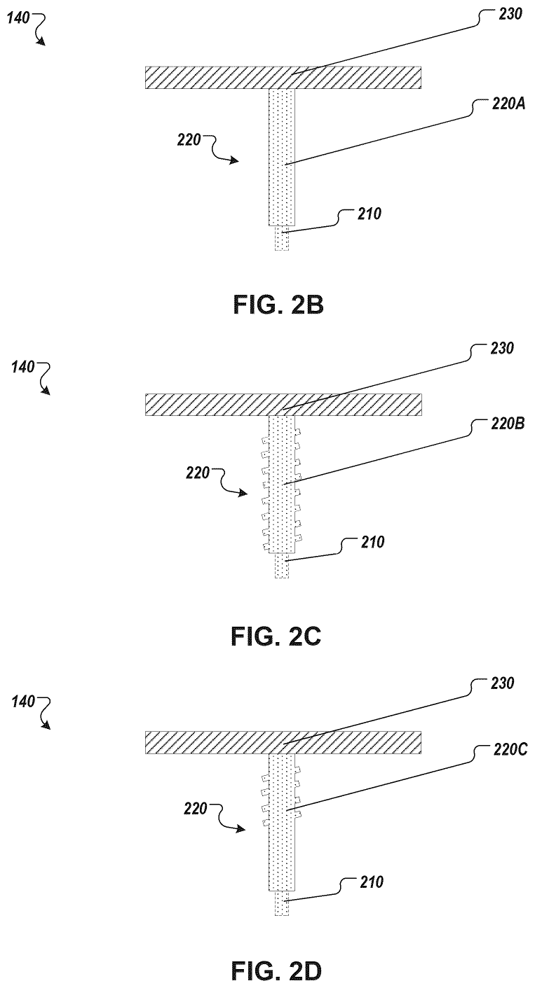

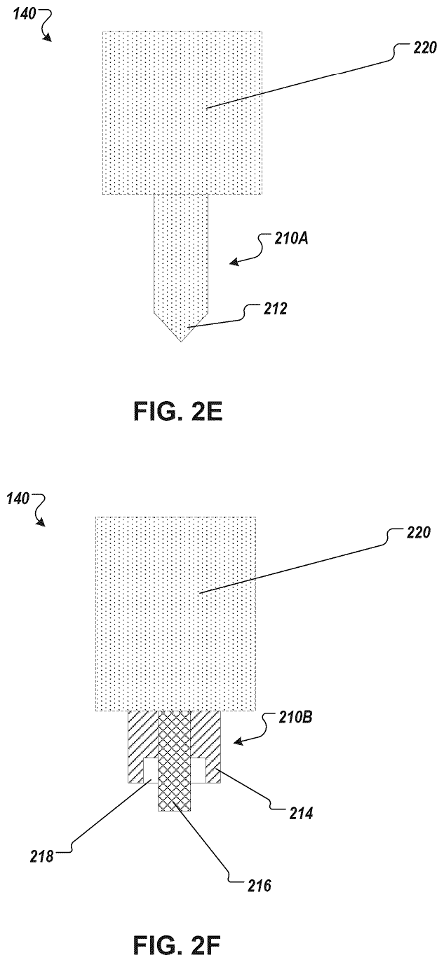

The rod structure 140 may be made from the same type of material as the body structure 110. In some embodiments, the rod structure 140 may be made from a different type of material than the type of material of the body structure 110. In some embodiments, the rod structure 140 may be a threaded rod structure (e.g., outer portion of a post of the rod structure 140 has external threads). In some embodiments, a distal end of the rod structure 140 may be configured to pass through the rod channel 133 and enter the fastener opening 135 (and/or the material fastening receptacle structure 310 of FIG. 3). In some embodiments, at least a portion of the rod structure 140 may be configured to pass through the rod channel 133 by applying pressure to a top portion of the rod structure 140. In some embodiments, at least a portion of the rod structure 140 may be configured to pass through the rod channel 133 by rotating the rod structure 140 about a substantially vertical axis (e.g., by turning the rod structure 140 in a clockwise or counterclockwise motion). The substantially vertical axis may be a central axis of a rod post of the rod structure 140 that at least partially passes through the rod channel 133 (e.g., by aligning the central axis of the rod post with a central axis of the rod channel 133). In some embodiments, the material fastening system 100 includes multiple rod structures 140 (e.g., one or more of rod structures 140 of FIGS. 2A-F). For example, a first rod structure 140 may be used to pierce materials and a second rod structure 140 may be used to secure the materials together via a fastener. In some embodiments, a single rod structure 140 is used to both pierce the materials and secure the materials together via a fastener.

FIGS. 2A-F illustrate rod structures 140 of material fastening systems (e.g., material fastening system 100 of FIG. 1A and/or FIG. 1B), in accordance with some embodiments of the disclosure. FIG. 2A illustrates a front cross-sectional view of a rod structure 140. FIGS. 2B-D illustrate front cross-sectional views of a rod structure 140 with varying types of rod posts 220. FIGS. 2E-F illustrate front cross-sectional views of varying types of rod tips 210 of a rod structure 140. In some embodiments, the rod structure 140 is a T-bar rod structure that has a rod handle 230 and a rod post 220 that are substantially perpendicular to each other. In some embodiments, the rod handle 230 and the rod post 220 are one contiguous piece (e.g., are integral to each other). In some embodiments, the rod handle 230 and the rod post 220 are separate pieces that are coupled to (e.g., connected to, fastened to, adhered to, threaded into, etc.) each other. In some embodiments, the rod tip 210 and the rod post 220 are one contiguous piece (e.g., integral to each other). In some embodiments, the rod tip 210 and the rod post 220 are separate pieces that are removably coupled to (e.g., connected to, fastened to, friction fit to, threaded into, etc.) each other. In some embodiments, the rod tip 210 and the rod post 220 are separate pieces that are removably coupled via a pin (e.g., via friction fit, via tension, via slip fit, via press fit, via spring force, via clip and pin, via detent, via tapered pin, via clevis pin, via cotter pin, via snap pin, via hitch pin, via a bent pin, via a hitch pin clip, via a lynch pin, etc.).

FIG. 2A illustrates a front cross-sectional view of a rod structure 140. The rod structure 140 may include a rod handle 230 coupled to (e.g., attached to, integral to) a rod post 220 that has a rod tip 210. In some embodiments, the rod structure 140 may be made from the same material as a body structure (e.g., body structure 110 of FIG. 1A). In some embodiments, the rod structure 140 may be made from a material different from the material of the body structure. In some embodiments, the rod handle 230 may be made from the same material as other portions of the rod structure 140. In some embodiments, the rod handle 230 may be made from a material different from the material of other portions of the rod structure 140. In some embodiments, the rod post 220 may be made from the same material as other portions of the rod structure 140. In some embodiments, the rod post 220 may be made from a material different from the material of other portions of the rod structure 140. In some embodiments, the rod handle 230 may be made from the same material as the rod post 220. In some embodiments, the rod handle 230 may be made from a material different from the material of the rod post 220. In some embodiments, the rod handle 230, the rod post 220, and the rod tip 210 are integral to each other (e.g., are a single structure)

In some embodiments, the rod tip 210 may be configured to pass through a rod channel (e.g., the rod channel 133 of FIG. 1B). In some embodiments, the rod tip 210 may be substantially pointed (e.g., sharp enough to pierce one or more materials and create a hole as shown in FIG. 2E). In some embodiments, the rod tip 210 may include an inner post and an outer sleeve (e.g., configured to fit within and encase a rivet simultaneously as shown in FIG. 2F).

FIGS. 2B-D illustrate front cross-sectional views of a rod structure 140 with varying types of rod posts 220. FIG. 2B illustrates a front cross-sectional view of a rod structure 140 with a substantially smooth rod post 220A (e.g., rod post 220A is substantially cylindrical). FIG. 2C illustrates a front cross-sectional view of a rod structure 140 with a substantially full-length externally threaded rod post 220B (e.g., a substantially fully threaded rod structure, rod post 220B has a substantially cylindrical portion and threads extending from the substantially cylindrical portion). FIG. 2D illustrates a front cross-sectional view of a rod structure 140 that includes a partial length (e.g., substantially half-length) externally threaded rod post 220C (e.g., a partial-threaded rod structure, substantially half-threaded rod structure, rod post 220B has a substantially cylindrical portion and threads extending from a portion of the substantially cylindrical portion). The rod structure 140 may further include a rod handle 230 coupled to (e.g., attached to, integral to) a rod post 220 that has a rod tip 210.

FIG. 2B illustrates a front cross-sectional view of a rod structure 140 that has a substantially smooth rod post 220A. An outer diameter of the rod post 220A may be substantially the same width as an inside diameter of the rod channel 133 formed by the first protruding portion 132 to cause a friction fit between the rod post 220A and the first protruding portion 132 at the rod channel 133.

FIG. 2C illustrates a front cross-sectional view of a rod structure 140 that has a threaded rod post 220C. In some embodiments, the rod structure 140 may be a threaded rod structure or a substantially fully threaded rod structure (e.g., an external threading substantially extends from the rod handle 230 to the rod tip 210). In some embodiments, the rod post 220 may be a substantially fully threaded rod post 220B that includes threads. In some embodiments, the substantially full-length externally threaded rod post 220B may be configured to pass through a threaded rod channel (e.g., the rod channel 133 of FIG. 1B) by rotating the rod structure 140 about a substantially vertical axis (e.g., turning the rod structure 140 in a clockwise or counterclockwise motion).

FIG. 2D illustrates a front cross-sectional view of a rod structure 140 that includes a partial length (e.g., substantially half-length) externally threaded rod post 220C (e.g., a partial-threaded rod structure, substantially half-threaded rod structure). The rod structure 140 may further include a rod handle 230 coupled to (e.g., attached to, integral to) a partial-length (e.g., substantially half-length) externally threaded rod post 220C that has a rod tip 210. In some embodiments, the rod structure 140 may be a threaded rod structure or a partial-threaded (e.g., substantially half-threaded) rod structure. In some embodiments, the partial-length (e.g., substantially half-length) externally threaded rod post 220C may be a partial-threaded (e.g., substantially half-threaded) rod post that includes threads along a top portion of the rod post 220 (e.g., proximate the rod handle 230). The top portion may be approximately half the length of the full rod post 220. In some embodiments, the partial-length (e.g., substantially half-length) externally threaded rod post 220C has external threads that begin below the rod handle 230 and continue until a midpoint of the rod post. Below the midpoint, the partial-length (e.g., substantially half-length) externally threaded rod post 220C is substantially smooth (e.g., no longer has threading). In some embodiments, a partial-threaded (e.g., substantially half-threaded) rod structure may be configured to pass through the rod channel 133 without twisting the rod structure 140 until the midpoint enters the rod channel 133 (e.g., until the substantially half-length externally threaded rod post 220C reach the rod channel 133). When the midpoint enters the rod channel 133, the partial-length (e.g., substantially half-length) externally threaded rod post may continue to pass through the rod channel 133 by rotating the rod structure 140 about a substantially vertical axis (e.g., turning the rod structure 140 in a clockwise or counterclockwise motion).

FIGS. 2E-F illustrate front cross-sectional views of varying types of rod tips 210 of a rod structure 140. FIG. 2E illustrates a front cross-sectional view of a piercing rod tip 210A. FIG. 2F illustrates a front cross-sectional view of a fastener receiving rod tip 210B. In some embodiments, the rod tip 210 (e.g., piercing rod tip 210A or fastener receiving rod tip 210B) is coupled to a rod post 220, which is coupled to a rod handle 230. For clarity, only a partial view of the rod post 220 is shown in FIGS. 2E-F, and the rod handle 230 is omitted from view.

FIG. 2E illustrates a front cross-sectional view of a piercing rod tip 210A. In some embodiments, the piercing rod tip 210A may be configured to pass through a rod channel (e.g., the rod channel 133 of FIG. 1B). In some embodiments, the piercing rod tip 210A includes a substantially pointed distal end 212 that is sharp enough to pierce one or more materials and create a hole in the one or more materials. In some embodiments, the piercing rod tip 210A may have a diameter of about 1.0 millimeters (mm) to about 4.0 mm.

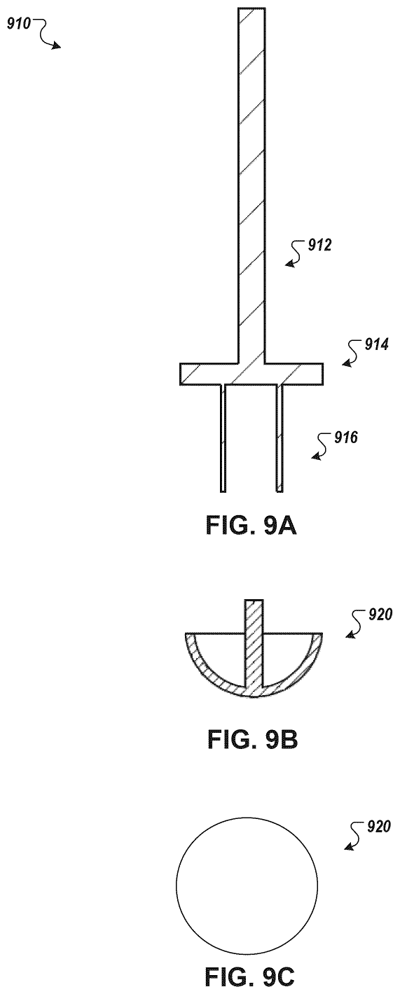

FIG. 2F illustrates a front cross-sectional view of a fastener receiving rod tip 210B. In some embodiments, the fastener receiving rod tip 210B may include an outer sleeve 214 and a solid inner post 216. The fastener receiving rod tip 210B may be configured to fit within and encase a fastener (e.g., rivet) simultaneously. In some embodiments, the fastener receiving rod tip 210B may have a diameter of about 1.0 mm to about 4.0 mm. In some embodiments, the fastener receiving rod tip 210B may have an outer sleeve 214 with a diameter of about 1.0 mm to about 4.0 mm, and a solid inner post 216 with a diameter of about 0.5 mm to about 3.5 mm. In some embodiments, the solid inner post 216 protrudes past the outer sleeve 214. In some embodiments, the solid inner post 216 and the outer sleeve 214 are integral to each other (e.g., are part of the same piece). In some embodiments, the outer sleeve 214 is coupled (e.g., fastened, adhered, secured, etc.) to the solid inner post 216. In some embodiments, the outer sleeve 214 and the solid inner post 216 are separated by a rivet receiving rod tip channel 218 (e.g., a gap, fastener receiving rod tip channel) configured to interface with a protruding portion (e.g., the protruding portion 916 of FIG. 9A) of a fastener (e.g., a rivet, the fastener 910 of FIG. 9A), such that when force is applied to the rod structure 140, the rod tip channel 218 causes the protruding portion of a fastener to fold (e.g., crimp, flare, etc.) onto an upper surface of the one or more materials to secure one or more materials between the folded (e.g., crimped, flared) protruding portion (e.g., see protruding portion 916 of FIG. 9A) and the (e.g., see backing portion 914 of FIG. 9A). In some embodiments, the solid inner post 216 may be configured to insert into an opening formed by a fastener (e.g., an opening formed by a protruding portion of a rivet), while the outer sleeve 214 encompasses (e.g., surrounds at least a portion of the protruding portion of the rivet) the fastener (e.g., a rivet), such that the fastener (e.g., rivet) occupies (e.g., is at least partially disposed in) the rivet receiving rod tip channel 218.

FIG. 3 illustrates a cross-sectional side view of components of a material fastening system 100, in accordance with some embodiments of the disclosure. The material fastening system 100 may include a body structure 110 and a material fastening receptacle structure 310. The body structure 110 may include a handle portion 120, a first protruding portion 132 forming a rod channel 133, and a second protruding portion 134 forming a fastener opening 135. The material fastening receptacle structure 310 may include a first surface 320 (e.g., upper surface) forming a material penetrating channel 325 and a second surface 330 (e.g., lower surface) forming a fastener (e.g., rivet) securing channel 335. The first surface 320 and the second surface 330 may be substantially opposite each other.

In some embodiments, the material fastening receptacle structure 310 may be made from the same material as the body structure 110. In some embodiments, the material fastening receptacle structure 310 may be made from a material that is different from the body structure 110. In some embodiments, the material fastening receptacle structure 310 may be a threaded material fastening receptacle structure. In some embodiments, the material fastening receptacle structure 310 may be configured to cover the fastener opening 135 (e.g., fit inside the fastener opening 135).

In some embodiments, the material fastening receptacle structure 310 may include a first surface 320 and a second surface 330. In some embodiments, a protrusion formed by the first surface 320 may be configured to fit inside (e.g., be threaded into) the fastener opening 135. Responsive to the material fastening receptacle structure 310 being positioned such that the second surface 330 faces the fastener opening 135 (e.g., flipped the material fastening receptacle structure 310 over), a protrusion formed by the second surface 330 may be configured to fit inside (e.g., be threaded into) the fastener opening 135. In some embodiments, the first surface 320 may form a material penetrating channel 325. In some embodiments, the second surface may form a fastener securing channel 335. In some embodiments, the material penetrating channel 325 may be configured to receive a piercing rod tip (e.g., the piercing rod tip 210A of FIGS. 2D-F) to cause the rod tip to pierce or penetrate the material. In some embodiments, the fastener securing channel 335 may be configured to receive a rod tip (e.g., the rod tip 210 of FIG. 2A). In some embodiments, a channel passes through the material fastening receptacle structure 310 so that a post of a fastener can pass through the material fastening receptacle structure 310.

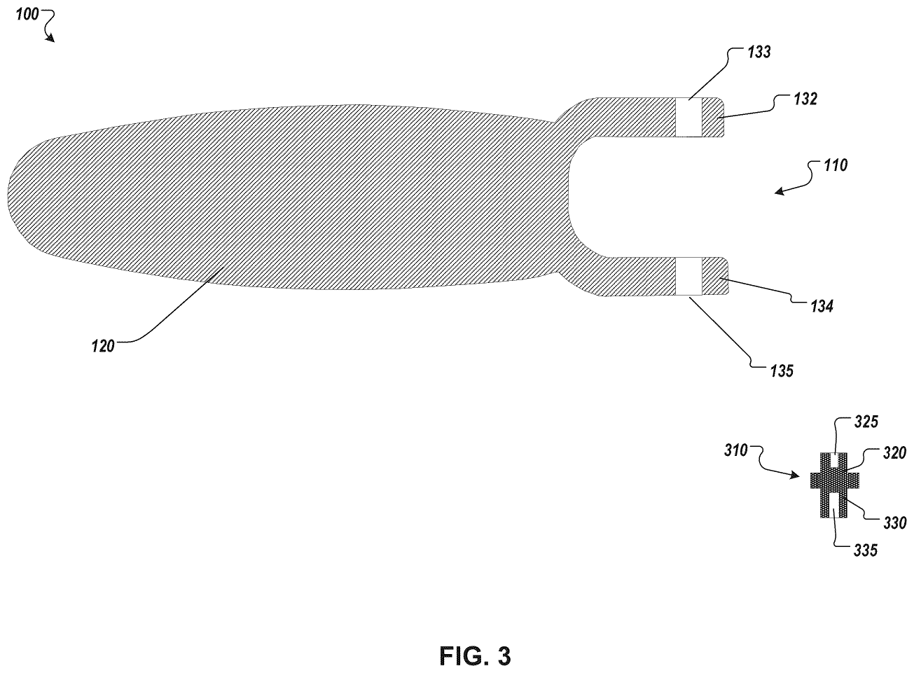

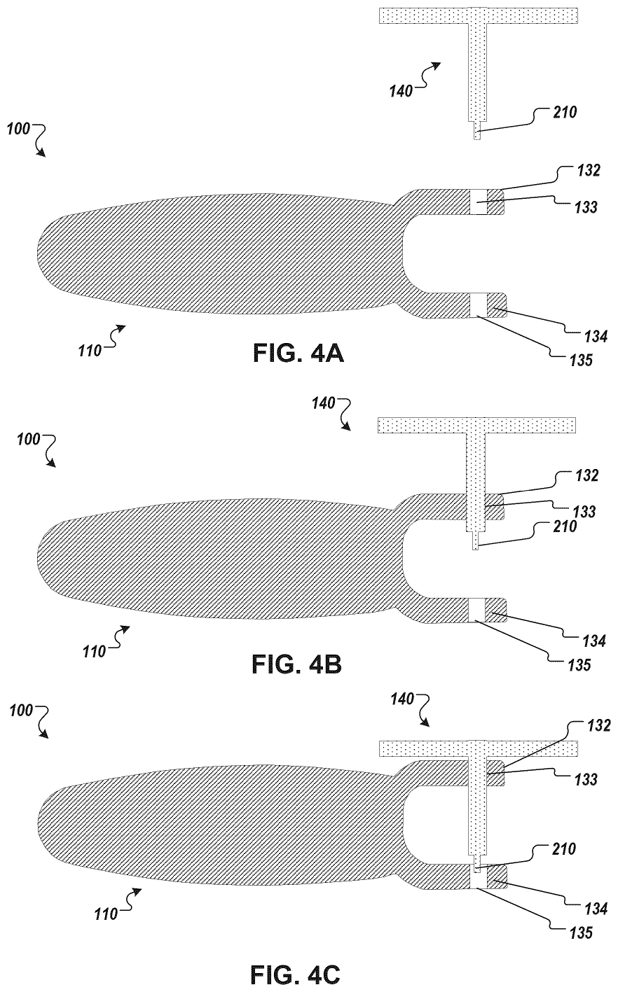

FIGS. 4A-C illustrate material fastening systems 100, in accordance with some embodiments of the disclosure.

Referring to FIG. 4A, material fastening system 100 may include a rod structure 140 that is not coupled to (e.g., is disposed above, not inserted into) a material fastening system 100.

Referring to FIG. 4B, a portion of the rod structure 140 may pass through (e.g., be inserted into, threads into) a rod channel 133 of a first protruding portion 132 of the body structure 110.

Referring to FIG. 4C, a rod tip 210 of the rod structure 140 may enter a fastener opening 135 of a second protruding portion 134 of the body structure 110 and/or enter a material fastening receptacle structure 310 coupled to the second protruding portion 134. In some embodiments, the rod tip 210 may be a piercing rod tip 210A and/or a fastener receiving rod tip 210B.

In some embodiments, FIG. 4A is a first state when the rod structure 140 is separate from the body structure 110 of the material fastening system 100.

In some embodiments, FIG. 4B is a second state when the rod structure 140 is at least partially inserted into the rod channel 133 of the first protruding portion 132.

In some embodiments, FIG. 4C is a third state when a distal portion of the rod structure 140 is fully inserted into the body structure 110 via the rod channel 133 of the first protruding portion 132 and has entered the fastener opening 135 of the second protruding portion 134 and/or the material fastening receptacle structure 310 coupled to the second protruding portion 134. In some embodiments, the rod structure 140 may at least partially pass through the rod channel 133 by applying a substantially downward pressure on the rod structure 140. In some embodiments, the rod structure 140 may at least partially pass through the rod channel 133 by rotating the rod structure 140 about a substantially vertical axis (e.g., turning the rod structure 140 in a clockwise or counterclockwise motion, threading the rod structure 140 into the rod channel 133).

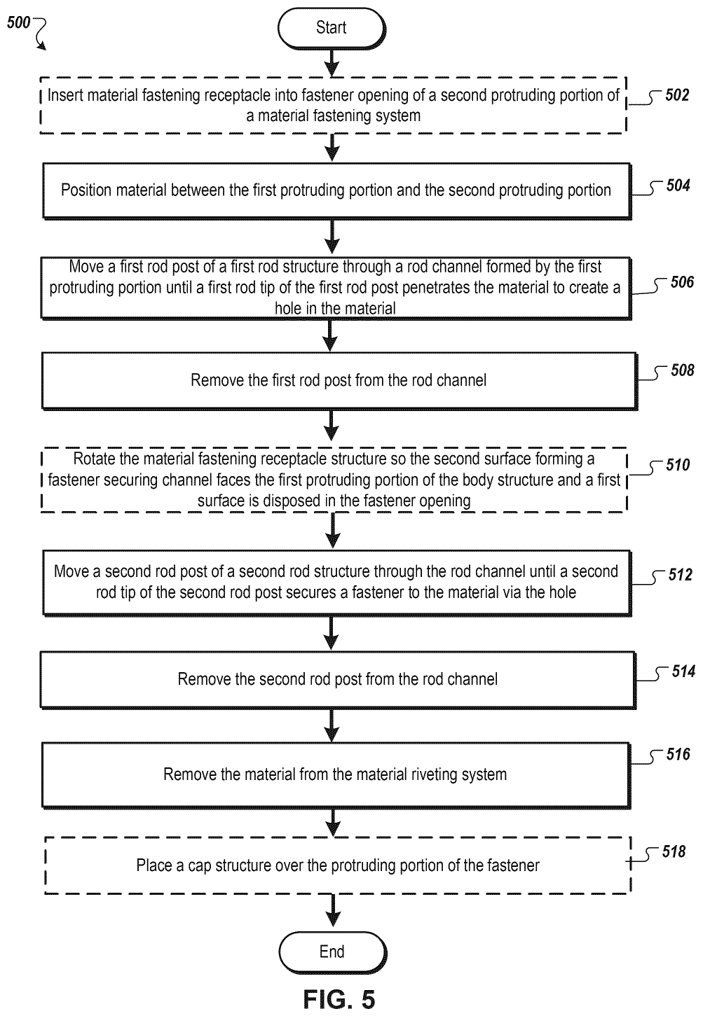

FIG. 5 depicts a flow diagram of an example method for using a material fastening system, in accordance with some embodiments of the disclosure. In some embodiments, method 500 may be performed by a material fastening system (e.g., the material fastening system 100 and/or components of one or more of FIGS. 1A-9C). In some embodiments, method 500 includes the operations of one or more of blocks 502 through 514. In some embodiments, method 500 includes additional operations or less operations than those shown in FIG. 5. In some embodiments, the order of the operations of method 500 are different than those shown in FIG. 5.

In some embodiments, at block 502, a material fastening receptacle structure (e.g., the material fastening receptacle structure 310 of FIG. 3) is inserted into a fastener opening (e.g., the fastener opening 135 of FIG. 1B) of a second protruding portion (e.g., the second protruding portion 134 of FIG. 1A) of a body structure of a material fastening system so that a material penetrating channel (e.g., the material penetrating channel 325 of FIG. 3) is facing toward a first protruding portion (e.g., the first protruding portion 132 of FIG. 1A) of the body structure (e.g., body structure 110 of FIG. 1A). A first surface (e.g., the first surface 320 of FIG. 3) may form the material penetrating channel. The first surface may be facing the first protruding portion of the body structure and a second surface (e.g., second surface 330 of FIG. 3) may be disposed in the fastener opening.

In some embodiments, at block 504, a material is positioned between the first protruding portion of the body structure and the second protruding portion of the body structure 110. In some embodiments, the first protruding portion and the second protruding portion are coupled via a handle portion (e.g., handle portion 120 of FIG. 1A) of the body structure 110. In some embodiments, the material is disposed directly on the fastener opening formed by the second protruding portion. In some embodiments, the material is disposed on the material fastening receptacle structure (e.g., the material is proximate the fastener opening). In some embodiments, the material may be a set of one or more materials.

In some embodiments, at block 506, a first rod post (e.g., the rod post 220 of FIG. 2A) of a first rod structure (e.g., the rod structure 140 of FIG. 1A) is moved through a rod channel (e.g., the rod channel 133 of FIG. 1A) formed by the first protruding portion until a first rod tip (e.g., the piercing rod tip 210A of FIG. 2E) of the first rod post penetrates (e.g., pierces) the material to create a hole in the material. In some embodiments, the material fastening receptacle is absent (e.g., removed) from the fastener opening while the first rod post penetrates the material to create a hole in the material. In some embodiments, the material fastening receptacle is present with a first surface (e.g., the first surface 320 of FIG. 3) facing toward the rod channel, such that a material penetrating channel (e.g., the material penetrating channel 325 of FIG. 3) is facing the rod channel (e.g., to receive the first rod tip).

In some embodiments, at block 508, the first rod post may be removed from the rod channel. In some embodiments, removing the rod post from the rod channel may be done by reversing the rod post out of the rod channel. In some embodiments, removing the rod post includes pulling the rod post out of the rod channel via the rod handle. In some embodiments, removing the rod post includes turning the rod post the opposite way (e.g., counterclockwise, clockwise) via the rod handle.

In some embodiments, at block 510, the material fastening receptacle structure may be inserted into the fastener opening such that a fastener securing channel (e.g., the fastener securing channel 335 of FIG. 3) is facing toward the rod channel. In some embodiments, the material fastening receptacle structure is already present with a material penetrating channel facing toward the rod structure. In this scenario, the material fastening receptacle structure may be rotated (e.g., flipped over) so that the second surface (e.g., the second surface 330 of FIG. 3) forming a fastener securing channel (e.g., the fastener securing channel 335 of FIG. 3) is facing the first protruding portion of the body structure and a first surface (e.g., the first surface 320 of FIG. 3) may be disposed in the fastener opening. In some embodiments, the material fastening receptacle structure is inserted again into the fastener opening.

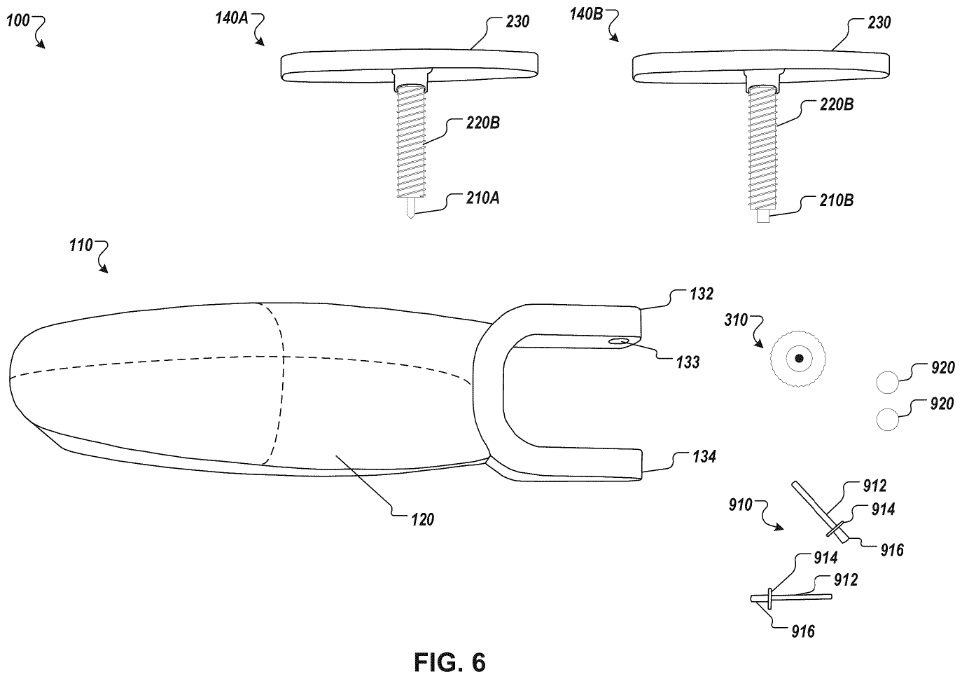

In some embodiments, at block 512, a second rod post of a second rod structure is moved through the rod channel until a second rod tip (e.g., the fastener receiving rod tip 210B of FIG. 2F) of the second rod post secures (e.g., crimps, rivets, flares, stakes, etc.) a fastener (e.g., a rivet) to the material via the hole. In some embodiments, the second rod tip forms a solid inner post (e.g., the solid inner post 216 of FIG. 2F) and an outer sleeve (e.g., the outer sleeve 214 of FIG. 2F) that interacts with a fastener shaft (e.g., protruding portion 916 of FIG. 9) of the fastener that protrudes away from the fastener opening. In some embodiments, the second rod tip crimps (e.g., folds down and flares) the fastener shaft of the fastener (e.g., rivet) such that the material is secured via the hole between the backing portion of a fastener (e.g., the backing portion 914 of FIG. 6) and the crimped fastener shaft. In some embodiments, a fastener post of the fastener passes through the fastener opening.

In some embodiments, at block 514, the second rod post may be removed from the rod channel. In some embodiments, removing the rod post from the rod channel may be done by reversing the rod post out of the rod channel. In some embodiments, removing the rod post includes pulling the rod post out of the rod channel via the rod handle. In some embodiments, removing the rod post includes turning the rod post the opposite way (e.g., counterclockwise, clockwise) via the rod handle.

In some embodiments, at block 516, the material may be removed from the material fastening system. In some embodiments, the material is now secured by a fastener (e.g., rivet).

In some embodiments, at block 518, a cap structure (e.g., the cap structure 920 of FIG. 9B and/or FIG. 9C) may be placed over the protruding portion 916 (e.g., fastener shaft) of the fastener 910 (e.g., rivet).

FIG. 6 illustrates components of a material fastening system 100, in accordance with some embodiments of the disclosure.

The material fastening system 100 may be used with rivets 910 and cap structures 920. A rivet 910 may include an interface portion 912, a backing portion 914, and a protruding portion 916. The rivets 910 and the cap structures 920 introduced here will be described in greater detail in connection with FIG. 9. Although some embodiments refer to rivets, other types of fasteners (e.g., solid tenon, hollow tenon, boss, flare, grommet, etc.) may be used. In some embodiments, the fastener 910 may not have an interface portion 912. In some embodiments, the fastener 910 may include one or more fastener pieces (e.g., a grommet type fastener has a top fastener piece and a bottom fastener piece).

In some embodiments, a material fastening system 100 may include a rod structure 140A and a rod structure 140B. The rod structure 140A may have a piercing rod tip 210A that is pointed or sharp (e.g., to puncture one or more materials) and a fastener receiving rod tip 210B that is configured to interface with a fastener, such as the rivet 910 (e.g., to fold the protruding portion 916 to secure the one or more materials between the protruding portion 916 and the backing portion 914). In some embodiments, the material fastening system 100 may include a single rod structure 140 with one or more interchangeable rod tips 210A and 210B. In some embodiments, interchangeable rod tips 210A and 210B may be threaded rod tips configured to be inserted into and removed from the rod post 220 of the single rod structure 140. In some embodiments, the rod tip 210 may be a single rod tip that is reversible (e.g., a first distal end includes rod tip 210A and a second distal end includes rod tip 210B) and configured to secure into the rod post 220 such that the desired rod tip is facing away from the rod handle 230 and the rod tip currently not in use is facing toward the rod handle 230 and concealed within the rod post 220. In some embodiments, the rod tip 210 is configured to secure (e.g., thread into, be magnetically coupled to) into the rod post 220. In some embodiments, the rod post 220 has a first type of rod tip 210 that is integral to the rod post 220 and a second type of rod tip 210 is configured to be secured over the first type of rod tip 210 (e.g., fits over the first type of rod tip 210).

In reference to the fastener (e.g., rivet) 910, the interface portion 912 may be used as a post of an earring (e.g., partially pass through ear and interface with an earring backing on the other side of the ear), as a pin of a broach (e.g., pass through clothing and interface with a broach backing on the other side of the clothing), etc. In some embodiments, the interface portion 912 may be a magnet to interface magnetically with a magnet that is on the other side of the clothing. In some embodiments, the interface portion 912 may be a clip of a clip-on earring to clip onto an ear. In some embodiments, the interface portion 912 may be configured to couple to a wall (e.g., to hang a picture on a wall).

The cap structure 920 may be configured to secure to the protruding portion 916 of the rivet 910 responsive to the protruding portion being folded. The cap structure 920 may couple with the protruding portion 916 via adhesive, friction fit, threading, magnetic attraction, and/or the like.

In some embodiments, the material fastening receptacle structure 310 is placed in a first orientation (e.g., with the first surface 320 of FIG. 3 facing the first protruding portion 132) on the second protruding portion 134, one or more materials are placed on the material fastening receptacle structure 310, and a rod structure 140A is inserted (e.g., threaded) partially through the first protruding portion 132 to puncture the one or more materials. The rod structure 140A may be removed (e.g., threaded out) from the first protruding portion 132, the one or more materials may be removed, the material fastening receptacle structure 310 may be flipped and placed in a second orientation (e.g., with the second surface 330 of FIG. 3 facing the first protruding portion 132) on the second protruding portion 134, a rivet 910 is placed in the material fastening receptacle structure 310 (e.g., the post of the interface portion 912 passing through the material fastening receptacle structure 310), the one or more materials are placed on the material fastening receptacle structure 310 with the protruding portion 916 passing through the puncture of the one or more materials, and the rod structure 140B is inserted (e.g., threaded) partially through the first protruding portion 132 to fold the protruding portion 916 onto the one or more materials to secure the one or more materials between the protruding portion and the backing portion 914. The rod structure 140B is then removed (e.g., threaded out) from the first protruding portion 132 and cap structure 920 is secured (e.g., via friction, via adhesive, via magnetic attraction, etc.) to the folded protruding portion 916.

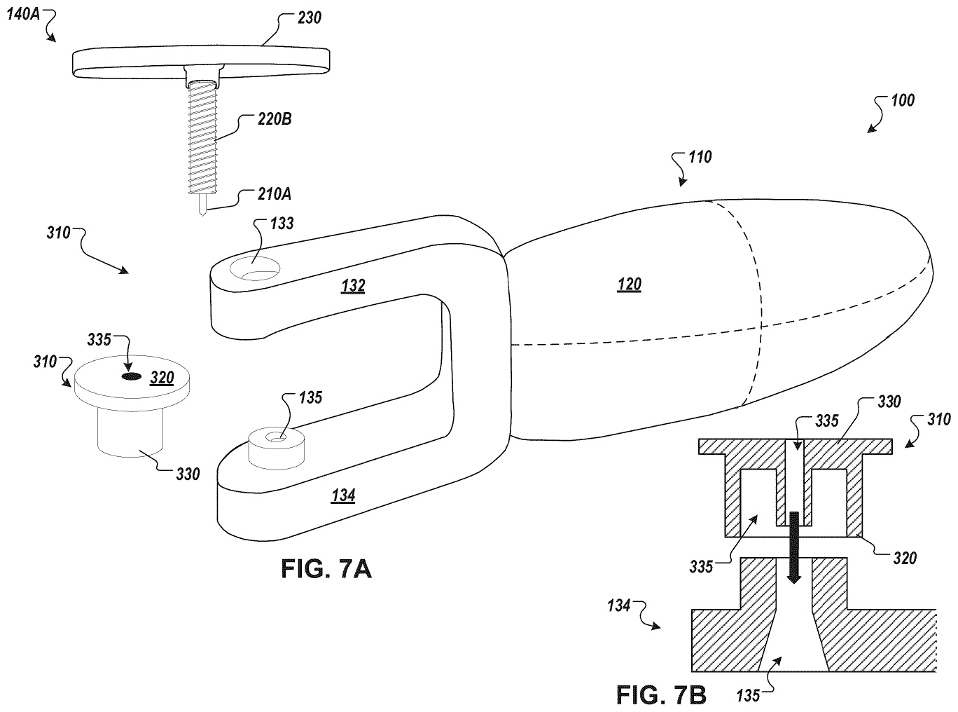

FIGS. 7A-B illustrate components of material fastening systems 100, in accordance with some embodiments of the disclosure. FIG. 7A is a perspective view of the material fastening system 100. FIG. 7B is a front cross-sectional view of the material fastening receptacle structure 310 (e.g., cap) and the second protruding portion 134 of the body structure 110 (e.g., cap slips over existing shaft hole that is larger from hole punch tool).

Material fastening system 100 may include a rod structure 140A with a piercing rod tip 210A, a body structure 110, and a material fastening receptacle structure 310. The body structure 110 may include a second protruding portion 134 that includes a protrusion that forms the fastener opening 135 (e.g., hole punch hole, larger hole from hole punch). The material fastening receptacle structure 310 may interface with the protrusion that forms the fastener opening 135.

The material fastening receptacle structure 310 may have a first surface 320 that is configured to interface with the protrusion that forms the fastener opening 135. First surface 320 may have an outer protruding surface configured to be disposed around the protrusion that forms the fastener opening 135 and an inner protruding surface configured to be disposed in the fastener opening 135. The material fastening receptacle structure 310 may have a second surface 330 that forms a fastener securing channel 335 (e.g., rivet hole, extends completely through the material fastening receptacle structure 310) configured to receive a post of a fastener such as a rivet 910 (e.g., fastener securing channel 335 is a smaller diameter to hold a portion of a fastener such as a post of a rivet 910). The fastener securing channel 335 may pass through the material fastening receptacle structure 310 and the fastener opening 135 may pass through the second protruding portion 134 so that a portion of a fastener such as a post of a rivet 910 may pass through the fastener securing channel 335 and the fastener opening 135.

Responsive to the material fastening receptacle structure 310 being removed from the body structure 110, the rod structure 140A may interface with the fastener opening 135 of the second protruding portion 134 which may pierce (e.g., penetrate or punch a hole in) the one or more materials disposed between the first protruding portion 132 and the second protruding portion 134.

Responsive to the material fastening receptacle structure 310 being coupled to (e.g., interfacing with) the protrusion of the second protruding portion 134 of the body structure 110, a portion of a fastener such as an interface portion 912 of a rivet 910 may be inserted into the fastener securing channel 335 and the rod structure 140 may interface with a portion of a fastener such as the protruding portion 916 of the rivet 910 to fold the protruding portion 916 of the rivet onto the one or materials.

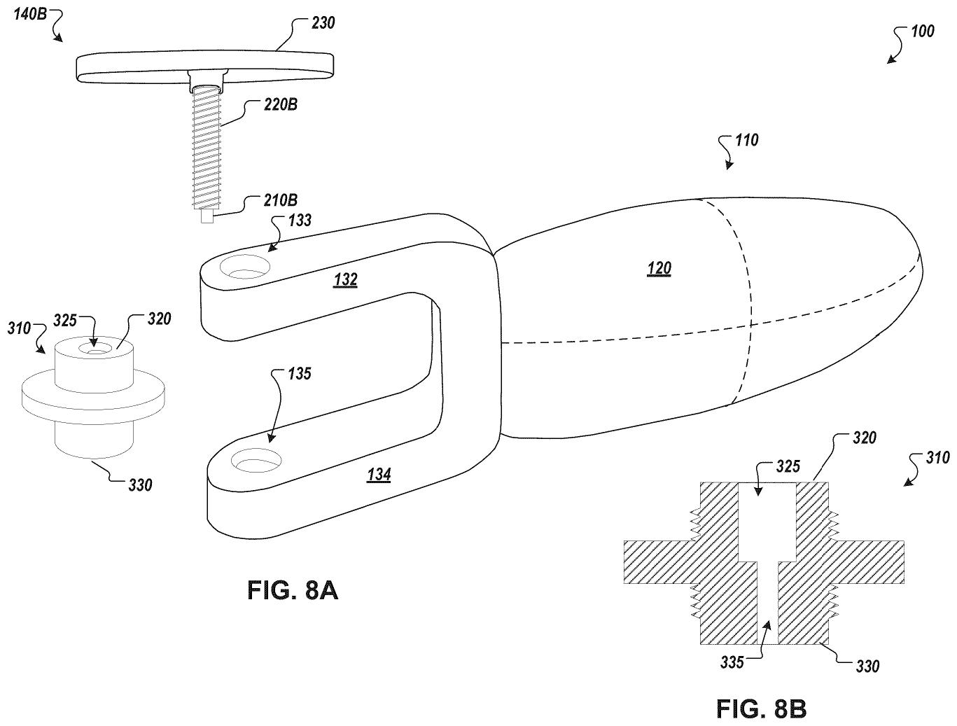

FIGS. 8A-B illustrate components of material fastening systems 100, in accordance with some embodiments of the disclosure. FIG. 8A is a perspective view of the material fastening system 100. FIG. 8B is a front cross-sectional view of the material fastening receptacle structure 310 and the second protruding portion 134 of the body structure 110.

Material fastening system 100 may include a rod structure 140B with a fastener receiving rod tip 210B, a body structure 110, and a material fastening receptacle structure 310. The body structure 110 may include a second protruding portion 134 that forms the fastener opening 135. The material fastening receptacle structure 310 may interface with the second protruding portion 134 via the fastener opening 135.

The material fastening receptacle structure 310 may have a first surface 320 that forms a material penetrating channel 325 (e.g., hole punch). The material fastening receptacle structure 310 may have a second surface 330 that forms a fastener securing channel 335 (e.g., rivet holder, fastener holder, etc.) configured to secure a fastener such as a rivet 910 (e.g., fastener securing channel 335 is a smaller diameter to hold a portion of a fastener such as a post of a rivet 910). The fastener securing channel 335 may pass through the material fastening receptacle structure 310 and the fastener opening 135 may pass through the second protruding portion 134 so that a portion of a fastener such as a post of a rivet 910 may pass through the fastener securing channel 335 and the fastener opening 135.

The material fastening receptacle structure 310 in a first orientation may have the second surface 330 couple to (e.g., thread into) the second protruding portion 134 so that a material penetrating channel 325 is facing the first protruding portion 132 and a rod structure 140 can partially pass through the first protruding portion 132 and puncture one or more materials disposed on the material fastening receptacle structure 310.

The material fastening receptacle structure 310 may be removed (e.g., unscrewed) from the second protruding portion 134 and rotated (e.g., flipped over) to a second orientation so that the first surface 320 couples to (e.g., threads into) the second protruding portion 134 so that a fastener securing channel 335 is facing the first protruding portion 132. A fastener (e.g., rivet 910) is disposed in the fastener securing channel 335, one or more materials disposed so that a protruding portion of the fastener such as the protruding portion 916 of the rivet 910 passes through the opening of the one or more materials, and a rod structure 140B partially passes through the first protruding portion 132 to fold the protruding portion of the fastener such as the protruding portion 916 of the rivet 910 onto the one or more materials.

In some embodiments, punched holes of the one or more materials are pushed out and ejected responsive to the fastener (e.g., rivet 910) being inserted into the material fastening receptacle structure 310.

FIGS. 9A-C illustrate components used with material fastening systems (e.g., material fastening systems 100 of one or more of FIGS. 1A-8B), in accordance with some embodiments of the disclosure.

FIG. 9A is a cross-sectional front view of a rivet 910 including an interface portion 912 (e.g., fastener post, rivet post), a backing portion 914 (e.g., fastener head, rivet head), and a protruding portion 916 (e.g., fastener shaft, rivet shaft). The protruding portion 916 (e.g., rivet shaft) is configured to protrude away from the fastener opening 135 of the body structure 110 (e.g., protrude toward the first protruding portion 132 of the body structure 110) and the interface portion 912 (e.g., rivet post) is configured to protrude into the fastener opening 135 of the body structure 110. FIG. 9B is a cross-sectional front view of a cap structure 920. FIG. 9C is an upper view of a cap structure 920.

In some embodiments, a fastener may be a rivet 910. Rivet 910 may be secured by a material fastening system 100, where one or more materials may be placed on the rivet 910 so that the protruding portion 916 passes through an opening of the one or more materials. A rod structure 140B with a fastener receiving rod tip 210B of the material fastening system 100 may interface with the protruding portion 916 of the rivet 910. A solid inner post 216 of the fastener receiving rod tip 210B may be inserted into an opening formed by the protruding portion 916 and an outer sleeve 214 of the fastener receiving rod tip 210B may be disposed around the protruding portion 916. The rod structure 140B may exert force on the protruding portion 916 in the direction of the backing portion 914 to cause the protruding portion 916 to fold onto the one or more materials to secure the one or more materials between the folded protruding portion 916 and the backing portion 914.

The cap structure 920 may have a protrusion that interfaces with the opening formed by the protruding portion 916. The cap structure 920 may attach to the protruding portion 916 via one or more of friction fit, adhesive, magnetic attraction, and/or the like.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A material fastening system comprising:
a body structure comprising:
a handle portion;
a first protruding portion extending from the handle portion, the first protruding portion forming a rod channel; and
a second protruding portion extending from the handle portion, the second protruding portion forming a fastener opening configured to receive a fastener, wherein one or more materials are to be disposed between the first protruding portion and the second protruding portion; and
a rod structure configured to at least partially pass through the rod channel and at least one of:
penetrate the one or more materials disposed between the first protruding portion and the second protruding portion; or
secure the fastener to the one or more materials disposed between the first protruding portion and the second protruding portion.

2. The material fastening system of claim 1, wherein:
the rod channel is a threaded rod channel;
the rod structure is a threaded rod structure; and
the threaded rod structure is to be threaded into the body structure via the threaded rod channel.

3. The material fastening system of claim 1, wherein the rod structure comprises a rod handle and a rod post that extends from the rod handle, and wherein a distal portion of the rod post is configured to pass through the rod channel and penetrate the one or more materials.

4. The material fastening system of claim 3, wherein at least a portion of the rod post is configured to pass through the rod channel responsive to the rod structure being rotated about a vertical axis of the rod post, the rod channel being disposed along the vertical axis.

5. The material fastening system of claim 1, wherein the rod structure comprises a rod tip configured to at least one of penetrate the one or more materials or secure the fastener to the one or more materials.

6. The material fastening system of claim 5, wherein the rod tip is substantially pointed.

7. The material fastening system of claim 5, wherein the rod tip comprises:
a solid inner post; and
an outer sleeve disposed around the solid inner post, wherein a gap is between the solid inner post and the outer sleeve.

8. The material fastening system of claim 1 further comprising a material fastening receptacle structure, wherein the material fastening receptacle structure is configured to cover the fastener opening.

9. The material fastening system of claim 8, wherein the material fastening receptacle structure is threaded and is configured to secure into the fastener opening of the second protruding portion via threading.

10. The material fastening system of claim 8, wherein the material fastening receptacle structure has a first surface and a second surface that is opposite the first surface, the first surface forming a material penetrating channel associated with penetrating the one or more materials and the second surface forming a fastener securing channel associated with fastening the one or more materials.

11. The material fastening system of claim 1, wherein:
the rod structure is configured to secure the fastener;
the fastener comprises a fastener post, a fastener head, and a fastener shaft; and
the fastener shaft is configured to protrude away from the fastener opening and the fastener post is configured to protrude into the fastener opening.

12. A material fastening device comprising:
a body structure comprising:
a handle portion;
a first protruding portion extending from the handle portion, the first protruding portion forming a rod channel configured to receive a first distal portion of a rod post of a rod structure, the rod structure comprising a rod handle proximate a second distal portion of and the rod post; and
a second protruding portion extending from the handle portion, the second protruding portion forming a fastener opening associated with receiving a fastener, wherein one or more materials are to be disposed between the first protruding portion and the second protruding portion.

13. The material fastening device of claim 12, wherein:
the rod channel is a threaded rod channel configured to receive a threaded rod structure; and
the threaded rod structure is to be threaded into the body structure via the threaded rod channel.

14. The material fastening device of claim 12, wherein the rod structure is configured to pass through the rod channel responsive to the rod structure being rotated about an axis of the rod channel.

15. The material fastening device of claim 12 further comprising a material fastening receptacle structure, wherein the fastener opening is configured to receive a portion of the material fastening receptacle structure.

16. The material fastening device of claim 15, wherein the material fastening receptacle structure is threaded.

17. The material fastening device of claim 15, wherein the material fastening receptacle structure has a first surface and a second surface that is opposite the first surface, the first surface forming a material penetrating channel associated with penetrating the one or more materials and the second surface forming a fastener securing channel associated with fastening the one or more materials.

18. A method comprising:
positioning a material between a first protruding portion of a material fastening system and a second protruding portion of the material fastening system, wherein the first protruding portion and the second protruding portion are coupled via a handle portion, and wherein the material is proximate a fastener opening formed by the second protruding portion;
moving a first rod post of a first rod structure through a rod channel formed by the first protruding portion until a first rod tip of the first rod post penetrates the material to create a hole in the material;
removing the first rod post from the rod channel; and
moving a second rod post of a second rod structure through the rod channel until a second rod tip of the second rod post secures a fastener to the material via the hole, wherein the second rod tip forms a solid inner post and an outer sleeve disposed around the solid inner post that interacts with a fastener shaft of the fastener that protrudes away from the fastener opening, wherein a fastener post passes through the fastener opening.

19. The method of claim 18 further comprising inserting a material fastening receptacle into the fastener opening with a first surface of the material fastening receptacle comprising a material penetrating channel associated with piercing the material responsive to the first surface facing the first protruding portion.

20. The method of claim 19 further comprising inserting the material fastening receptacle into the fastener opening with a second surface of the material fastening receptacle comprising a fastener securing channel associated with securing the fastener to the material responsive to the second surface facing the first protruding portion.
